(19) United States
(12) Patent Application Publication
(10) Pub. No.: US 2017/0027316 A1
(43) Pub. Date: Feb. 2, 2017

(54) CONVERTIBLE SIMULATION APPARATUS

(71) Applicant: THE GENERAL HOSPITAL CORPORATION, Boston, MA (US)

(72) Inventors: Tanya M. Zinkus, Framingham, MA (US); James Gordon, Lexington, MA (US)

(21) Appl. No.: 15/302,774

(22) PCT Filed: Apr. 9, 2015
(86) PCT No.: PCT/US15/25112

§ 371 Date: Oct. 7, 2016

Related U.S. Application Data
(60) Provisional application No. 61/977,269, filed on Apr. 9, 2014.
(60) Provisional application No. 61/977,277, filed on Apr. 9, 2014.

(51) Int. Cl. A47B 46/00; A47B 83/04; A47B 81/00; G09B 23/28

(52) U.S. Cl. CPC A47B 46/005; G09B 23/28; A47B 83/045; A47B 81/00

(57) ABSTRACT

A convertible simulation apparatus for supporting a medical simulation device is provided. In one example, a convertible simulation apparatus is provided that includes a base having a substantially open top side, a cover, and a simulation platform. The simulation platform is configured to receive a medical simulation device and is mounted within the base such that the simulation platform is moveable between a first position where the medical simulation device is positioned substantially below the top side of the base and a second position where the medical simulation device protrudes from the top side of the base.

### CROSS-REFERENCES TO RELATED APPLICATIONS

The present application is based on, claims priority to, and incorporates herein by reference in their entirety, U.S. Provisional Patent Application No. 61/977,277, filed Apr. 9, 2014, and entitled “Convertible Simulation Cabinet,” and U.S. Provisional Patent Application No. 61/977,269, filed Apr. 9, 2014, and entitled “Convertible Simulation Table.”

### STATEMENT REGARDING FEDERALLY SPONSORED RESEARCH

Not Applicable.

### BACKGROUND

The disclosure relates generally to medical simulation and, more specifically a convertible simulation apparatus configured to store, secure, and provide operation of a medical simulation device.

Medical simulation devices allow physicians, nurses, students and other clinical providers, to obtain more frequent exposure and training for many medical procedures, therapies, and operations. Use of the medical simulation devices provide a safe training experience before having to perform the medical procedures on living patients. Furthermore, the medical simulation devices enable the training of certain medical procedures, therapies, and operations that are impractical to practice multiple times on a living patient. The training provided by the medical simulation devices can aid in the development of medical skills without putting patients at risk.

### BRIEF SUMMARY

The present disclosure provides an apparatus for supporting a medical simulation device. In particular, a convertible simulation apparatus is provided that can act as standard office furniture, such as a table or a cabinet, and be converted to provide a user access to a medical simulation device supported within the convertible simulation apparatus.

In one aspect, the present disclosure provides a convertible simulation apparatus including an enclosure and a simulation platform configured to receive a medical simulation device. The simulation platform is moveable between a first position where the medical simulation device is positioned within the enclosure and a second position where the medical simulation device is positioned outside of the enclosure. The simulation platform is configured to support a dynamic load in addition to a static load.

In another aspect, the present disclosure provides a convertible simulation apparatus including a base defining a substantially open top side and a cover attached to the base such that the cover is moveable between a first cover position where the cover covers the top side of the base and a second cover position where the cover does not cover the top side of the base. The convertible simulation device further includes a simulation platform configured to receive a medical simulation device. The simulation platform is mounted within the base such that the simulation platform is moveable between a first platform position where the medical simulation device is positioned substantially below the top side of the base and a second platform position where the medical simulation device protrudes from the top side of the base. The simulation platform is moveable between the first platform position and the second platform position when the cover is in the second cover position.

In yet another aspect, the present disclosure provides a convertible simulation apparatus including a cabinet having a door pivotally mounted to a first side of the cabinet and defining a door aperture arranged on the first side of the cabinet and dimensioned to receive the door. The convertible simulation apparatus further includes a simulation platform configured to receive a medical simulation device. The simulation platform includes a support feature pivotally attached to the simulation platform. The simulation platform is pivotally mounted within the cabinet such that the simulation platform is moveable between a first platform position where the simulation platform and the support feature are arranged substantially parallel to the first side of the cabinet thereby positioning the medical simulation device within the cabinet and a second platform position where the simulation platform is arranged substantially perpendicular to the first side of the cabinet and protrudes from the door aperture thereby positioning the medical simulation device outside of the cabinet. The simulation platform is moveable between the first platform position and the second platform position when the door is in the open position.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF DRAWINGS

The invention will be better understood and features, aspects and advantages other than those set forth above will become apparent when consideration is given to the following detailed description thereof. Such detailed description makes reference to the following drawings which are not necessarily to scale.

FIG. 1 shows a perspective view of a convertible simulation apparatus in accordance with one embodiment of the present disclosure.

FIG. 2 shows a front view of the convertible simulation apparatus of FIG. 1 illustrating a cover in a second cover position and a platform support feature.

FIG. 3 shows a perspective view of a convertible simulation apparatus in accordance with another embodiment of the present disclosure.

FIG. 4 shows a front view of the convertible simulation apparatus of FIG. 3 illustrating a cover in a second cover position and a platform support feature.

FIG. 5 shows a front view of the convertible simulation apparatus of FIG. 1 illustrating a cover in a second cover position and another platform support feature.

FIG. 6 shows a front view of the convertible simulation apparatus of FIG. 1 illustrating a cover in a second cover position and yet another platform support feature.

FIG. 7 shows a perspective view of a convertible simulation apparatus in accordance with still another embodiment of the present disclosure.

FIG. 8 shows a front view of the convertible simulation apparatus of FIG. 4 illustrating a cover in a second cover position and a platform support feature.

FIG. 9 shows a perspective view of a convertible simulation device in accordance with yet another embodiment of the present disclosure.

FIG. 10 shows a front view of the convertible simulation apparatus of FIG. 6.

FIG. 11 shows a rear view of the convertible simulation apparatus of FIG. 6.

### DETAILED DESCRIPTION

Currently, medical simulation devices are typically used in an environment representative of a care area in a hospital or other medical facility. Many of these facilities utilize actual patient beds or gurneys to hold the medical simulation devices. Therefore, the space required for a simulation area can be significant and the medical facilities are often required to purchase additional equipment for the medical simulation devices. Additionally, the complexity of the medical simulation device and the time required to set it up typically dictates that the medical simulation device is left set up and ready to operate. This situation typically results in the medical facilities dedicating an entire room or area to the medical simulation device and, therefore, trainees have to travel to the dedicated room or area rather than the medical simulation device being readily available in the trainees' department or native clinical environment.

Due to the added equipment costs and additional space requirements to support current medical simulation devices, it would be desirable to have a convertible simulation apparatus capable of securely storing a medical simulation device and providing easy access to the medical simulation device when needed in a manner than does not require dedicated space.

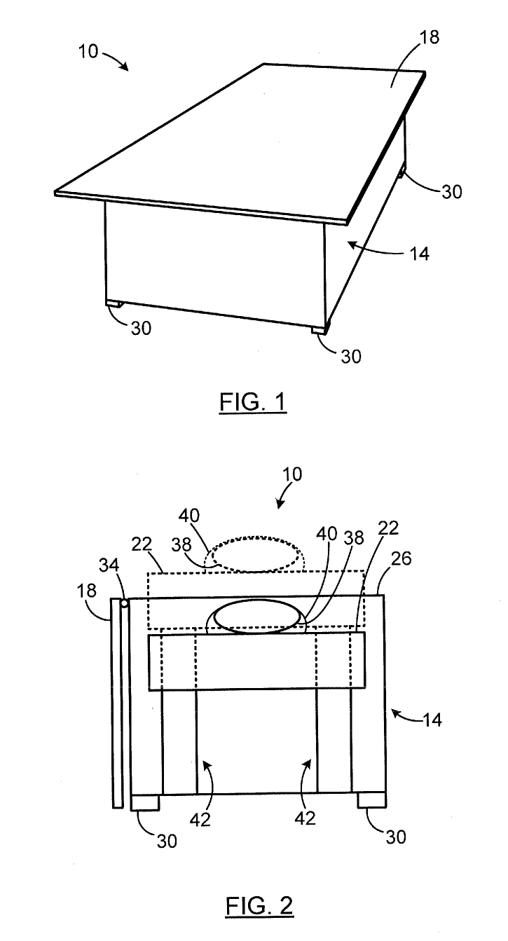

FIGS. 1 and 2 illustrate one non-limiting example of a convertible simulation apparatus 10 in accordance with the present disclosure. The convertible simulation apparatus 10 includes a base 14, a cover 18, and a simulation platform 22. The base 14 defines a substantially open top side 26 and includes a plurality of base mounting features 30 positioned between the base 14 and a floor the convertible simulation apparatus 10 is mounted upon. In the illustrated non-limiting example, the base 14 includes four base mounting features 30. In other non-limiting examples, the base 14 can include more or less base mounting features 30, as desired.

In one non-limiting example, the base mounting features 30 can be rubber feet which prevent the convertible simulation apparatus 10 from shifting on the floor. In another non-limiting example, the base mounting features 30 can be lockable casters configured to enable the convertible simulation apparatus 10 to be moved on the floor and locked in position, as desired.

In the illustrated non-limiting example of FIGS. 1 and 2, the cover 18 is attached to the base 14 using a positioning mechanism 34 and the cover 18 is dimensioned such that at least one of a longitudinal and a latitudinal dimension of the cover 18 is less than a distance from the top side 26 of the base 14 to the floor. The cover 18 is configured to be moveable between a first cover position (FIG. 1) where the cover 18 covers the top side 26 of the base 14 and a second position (FIG. 2) where the cover 18 does not cover the top side 26 of the base 14. The dimensioning of the cover 18 enables the cover 18 to be positioned outside of the base 14 and substantially perpendicular to the top side 26 of the base 14 without the cover 18 touching the floor when the cover 18 is in the second cover position. Alternatively or additionally, the cover 18 can include a locking feature configured to lock the cover 18 on the base 14 when the cover 18 is in the first cover position.

The pivoting mechanism 34 can include one or more hinges each coupled to a slot configured to guide the hinges along the base 14 and pivot the cover 18 between the first cover position and the second cover position. Alternatively or additionally, the positioning mechanism 34 can include one or more sliding tracks, such as, ball bearing tracks or low friction sliding surfaces, one or more slot-guided pivoting pins, one or more electronically controlled actuators, a mechanical linkage assembly, or any viable mechanism capable moving the cover 18 between the first cover position and the second cover position.

In other non-limiting examples, the cover 18 may not include the positioning mechanism 34 and the cover 18 may be removably attached to the base 14 using one or more removable attachment elements. The removable attachment elements can be in the form of a bolt and a nut, a dead bolt latch, a cam lock, a cross bar, a spring latch, a removable clamp, or any other viable mechanism capable of detaching the cover 18 from the base 14. Alternatively or additionally, the base 14 can include one or more cover mounting features and the cover 18 can includes one or more corresponding base mounting features configured to be received by the one or more cover mounting features. In this non-limiting example, the cover 18 can be manually removed from the base 14 by the user of the convertible simulation apparatus 10.

With continued reference to FIGS. 1 and 2, the simulation platform 22 is configured to receive a medical simulation device 38 which can be mounted upon the simulation platform 22 using one or more straps 40. The medical simulation device 38 can be any device used to simulate any medical procedure, therapy, operation, or training exercise known in the art. For example, the medical simulation device 38 can be a full-body manikin simulator including a torso, limbs, joints etc., a partial-body simulator, or a task simulator for training a particular task, procedure, or anatomic region of the body. The medical simulation device 38 can include sensors and actuators for simulating a patient's movements and reactions to a specific type of medical procedure, therapy, or operation. In one non-limiting configuration, the medical simulation device 38 can apply a static load of between approximately 100 pounds and 150 pounds to the simulation platform 22. The straps can prevent the medical simulation apparatus 38 from being caught within the base 14 or shifting off of the simulation platform 22.

The simulation platform 22 is mounted within the base 14 using a platform support feature 42. The platform support feature 42 is configured to enable the simulation platform 22 to be moveable between a first platform position where the medical simulation device 38 is positioned substantially below the top side 26 of the base 14 and a second platform position (shown using dashed lines in FIG. 2) where the medical simulation device 38 protrudes from the top side 26 of the base 14. The design of the platform support feature 42 and the simulation platform 22 can be such that the simulation platform 22 can support the static load of the medical simulation device 38 and a user, and any additional dynamic load applied to the simulation platform 22 without collapsing.

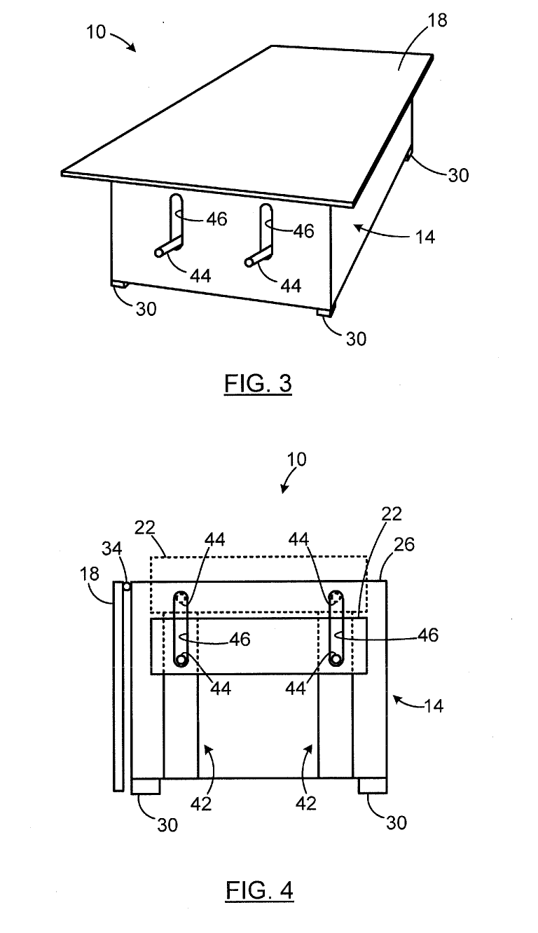

In one non-limiting example, the platform support feature 42 can include one or more actuators, as shown in FIG. 2. The one or more actuators can be electrically, hydraulically, pneumatically, or manually operated. Alternatively or additionally, the simulation platform 22 may include one or more support handles 44 each extending through a corresponding slot 46 in the base 14, as shown in FIG. 3. The one or more slots 46 can each include a notch or a latch for securing the simulation platform 22 in the first platform position and the second platform position. This could enable one or more users of to grasp the one or more support handles 44 and manually move the simulation platform 22 between the first platform position and the second platform position, as shown in FIG. 4.

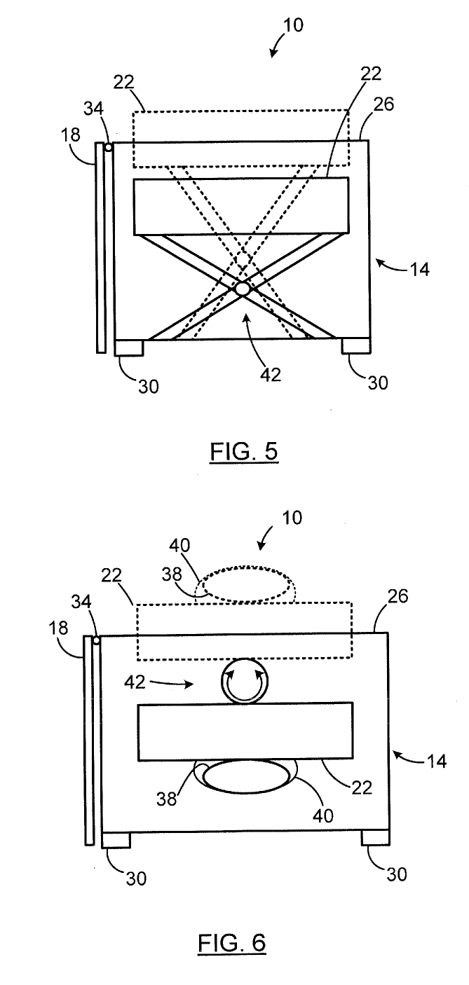

In another non-limiting example, the platform support feature 42 can be a scissor lift assembly, as shown in FIG. 5. In still another non-limiting example, the platform support feature 42 can be a rotational mechanism configured to rotate the simulation platform 22, as shown in FIG. 6. In this non-limiting configuration, when the simulation platform 22 is in the first platform position, the medical simulation device 38 can be upside-down and facing away from the top side 26 of the base 14 with the straps 40 securing the medical simulation device 38 to the simulation platform 22. Rotation of the simulation platform 22 can enable the simulation platform to move between the first platform position and the second platform position. In other non-limiting examples, the platform support feature 42 can include a mechanical linkage assembly, a pulley assembly, or any other viable displacement mechanism capable of moving the simulation platform 22 between the first platform position and the second platform position. Alternatively or additionally, a securing mechanism can be positioned under the simulation platform 22, once the simulation platform 22 is in the second platform position, to provide additional support to the simulation platform 22. The securing mechanism can support a portion of the load applied to the simulation platform 22 reducing the amount of the load supported by the platform support feature 42. Movement of the platform support feature 42 between the first platform position and the second platform position can be controlled either electronically or manually by the user of the convertible simulation apparatus 10.

One non-limiting example of operation of the convertible simulation apparatus 10 will be described below with reference to FIGS. 1 and 2. When the cover 18 is in the first cover position (FIG. 1), the convertible simulation apparatus 10 can act as a table to be used, for example in a conference room, a break room or office, and one or more chairs can be positioned under the cover 18 and around the base 14. When it is desired to use the medical simulation device 38, the cover 18 can be moved from the first cover position (FIG. 1) to the second cover position (FIG. 2) via the positioning mechanism 34. Once the cover 18 is in the second cover position, the simulation platform 22 can then be moved from the first platform position to the second platform position (shown in dashed lines in FIG. 2) via the platform support feature 42 providing a user of the convertible simulation apparatus 10 access to the medical simulation device 38. The user can then remove the straps 40 and perform the simulated medical procedure, therapy, operation, or other training exercise on the medical simulation device 38 while being observed by a trained medical professional. For example, the user can perform chest compressions on the medical simulation device 38 to simulate CPR. In this non-limiting example, the user would be positioned on the simulation platform 22 and the user would apply an additional static load of between approximately 100 pounds and 250 pounds to the simulation platform 22. During the chest compressions, the user would also be applying a dynamic load of between approximately 100 pounds and 125 pounds to the simulation platform 22. The simulation platform 22 can be configured to support a peak dynamic load equal to the sum of the static loads from the medical simulation device 38 and the user, plus the additional force from the chest compressions. Thus, the peak dynamic load supported the simulation platform 22, in this non-limiting example, is approximately 525 pounds. In other non-limiting examples, the simulation platform 22 can be configured to support a peak dynamic load between approximately 400 pounds and 600 pounds.

Once the user is finished with the medical simulation device 38, the simulation platform 22 can be moved from the second platform position to the first platform position via the platform support feature, and the cover 18 can be moved from the second cover position to the first cover position via the positioning mechanism 34. Upon moving the cover 18 back into the first cover position, the convertible simulation apparatus 10 can continue to be used as a table until the medical simulation device 38 is needed.

Movement of the cover 18 via the positioning mechanism 34 and/or movement of the simulation platform 22 via the platform mechanism 42 may be manually or electronically controlled by the user. For example, the convertible simulation apparatus 10 can include a control panel in electrical communication with the positioning mechanism 34 and/or the platform support feature 42. Alternatively, the convertible simulation apparatus 10 can include one or more manual movement devices, such as a pulley or a crank, mechanically coupled to the positioning mechanism 34 and/or the platform support feature 42.

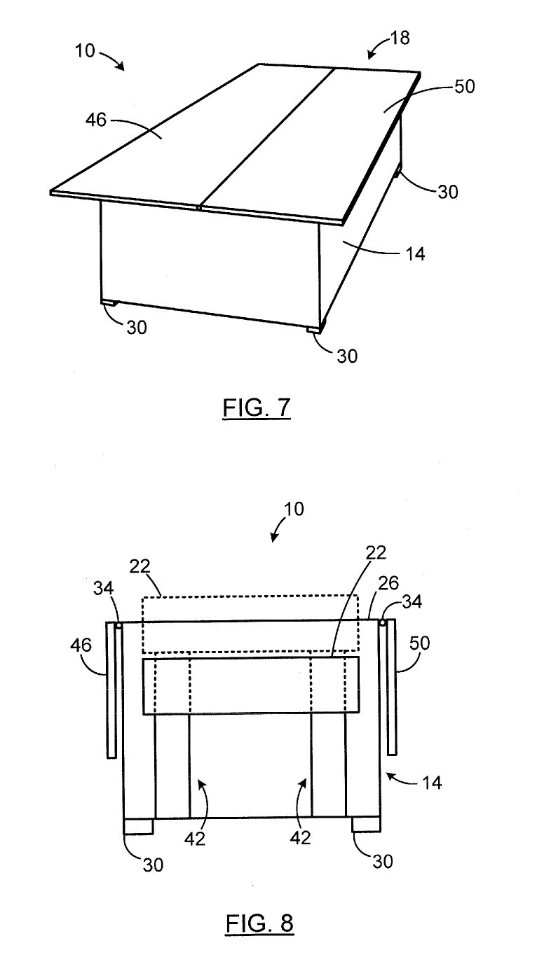

FIGS. 7 and 8 illustrate another non-limiting example of the convertible simulation apparatus 10. In this non-limiting example, the cover 18 is separated into a first cover section 46 and a second cover section 50. The first cover section 46 and the second cover section 50 are attached to the base 14 using the positioning mechanism 34, and are each dimensioned such that at least one of a longitudinal dimension and a latitudinal dimension is less than the distance from the top side 26 of the base 14 to the floor. When the cover 18 is in the first cover position (FIG. 7), the first cover section 46 engages the second cover section 50 to cover the top side 26 of the base 14. When the cover 18 is in the second cover position (FIG. 8), the first cover section 46 and the second cover section 50 are separated and positioned outside of the base 14 substantially perpendicular to the top side 26 of the base 14 without touching the floor.

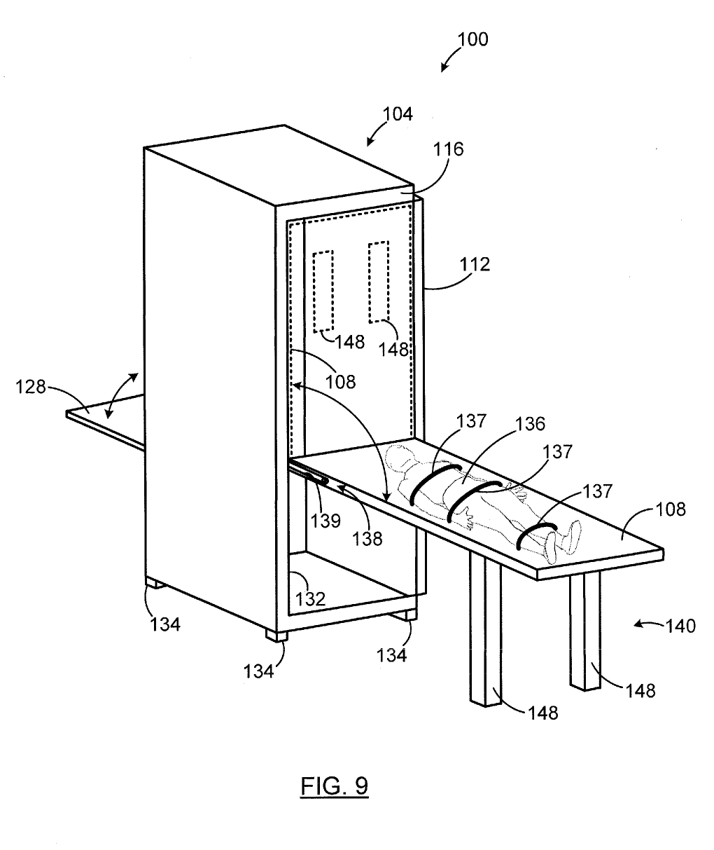

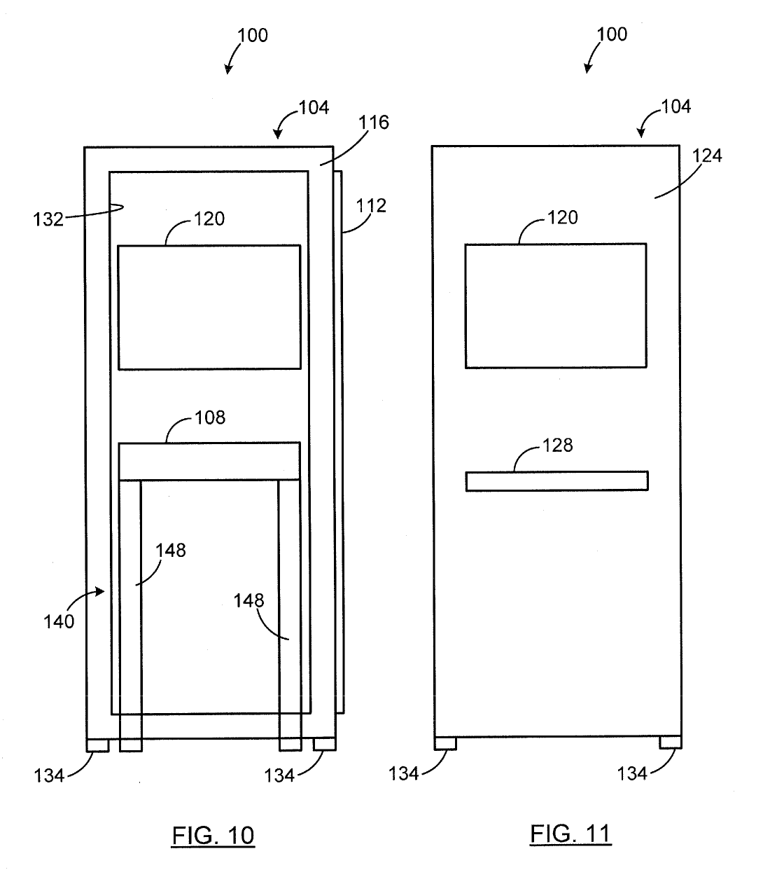

FIGS. 9-11 illustrate another non-limiting example of a convertible simulation apparatus 100 in accordance with the present disclosure. The convertible simulation apparatus 100 includes a cabinet 104 and a simulation platform 108. The cabinet 104 includes a door 112 mounted to a first side 116 of the cabinet 104, a two-way mirror 120 integrated into a second side 124 of the cabinet 104, and an operator mounting surface 128. The cabinet 104 defines a door aperture 132 arranged on the first side 116 of the cabinet 104 and dimensioned to receive the door 112. The cabinet is mounted upon a plurality of cabinet mounting features 134 arranged between the cabinet 104 and a floor in which the convertible simulation apparatus 100 is mounted upon. In the illustrated non-limiting example, the cabinet 104 includes four cabinet mounting features 134. In other non-limiting examples, the cabinet 104 can include more or less cabinet mounting features 134, as desired. Alternatively or additionally, the cabinet 104 may include one or more shelves arranged within the cabinet 104 for storage.

In one non-limiting example, the cabinet mounting features 134 can be rubber feet which prevent the convertible simulation apparatus 100 from shifting on the floor. In another non-limiting configuration, the cabinet mounting features 134 can be lockable casters configured to enable the convertible simulation apparatus 100 to be moved on the floor and locking in position, as desired.

The door 112 is mounted to the first side 116 of the cabinet 104 using one or more hinges (not shown). The door 112 is configured to be moveable between an open position where the door 112 is swung away from the door aperture 132 and positioned substantially perpendicular to the first side 116 of the cabinet 104, and a closed position where the door 112 is received by the door aperture 132. When in the first door position, a user can have unobstructed access to the simulation platform 108. Alternatively or additionally, the door 112 can include a locking feature configured to lock the door 112 to the cabinet 104 when the door 112 is in the closed position.

The two-way 120 mirror is configured to enable an operator to view the simulation platform 108 while a user positioned on or adjacent to the simulation platform 108 is inhibited from seeing the operator.

In one non-limiting example, the operator mounting surface 128 can be pivotally mounted to the second side 124 of the cabinet 104 using one or more hinges (not shown). The operator mounting surface 128 can be configured to be moveable between a first mounting position where the operator mounting surface 128 is arranged substantially perpendicular to the second side 124 of the cabinet 104 and a second mounting position where the operator mounting surface 128 is arranged substantially parallel to and in engagement with the second side 124 of the cabinet 104. When the operator mounting surface 128 is in the first mounting position, one or more simulation control devices can be mounted on the operator mounting surface 132. In another non-limiting configuration, the operator mounting surface 128 can be moveable into and out of the cabinet 104 through a slot in the second side 124 on the cabinet 104. In still another non-limiting example, the operator mounting surface 128 can be removable from the cabinet 104 and mounted on the second side 124 of the cabinet 104 by inserting the operator mounting surface 128 into clips attached to the second side 124 of the cabinet 104.

The simulation platform 108 is configured to receive a medical simulation device 136 which can be mounted upon the simulation platform 108. The simulation platform 108 includes a positioning mechanism 138 slidably received within a positioning slot 139, and a support feature 140 attached to the simulation platform 108. The medical simulation device 136 can be any device used to simulate any medical procedure, therapy, operation, or training exercise known in the art. For example, the medical simulation device 136 can be a full-body manikin simulator including a torso, limbs, joints etc., a partial-body simulator, or a task simulator for training a particular task, procedure, or anatomic region of the body. The medical simulation device 136 can include sensors and actuators for simulating a patient's movements and reactions to a specific type of medical procedure, therapy, or operation. In one non-limiting configuration, the medical simulation device 136 can apply a static load of between approximately 100 pounds and 150 pounds to the simulation platform 108. The medical simulation device 136 can be mounted upon the simulation platform 108 using one or more straps 137. The one or more straps can prevent the medical simulation device 136 from shifting off of the simulation platform 108. Alternatively or additionally, a sheet can be secured over and around the medical simulation device 136 on the simulation platform 108.

The positioning mechanism 138 and the positioning slot 139 enable the simulation platform 108 to be pivotally coupled to the cabinet 104 such that the simulation platform 108 is moveable between a first platform position (shown using dashed lines in FIG. 9) and a second platform position. When the simulation platform 108 is in the first platform position, the simulation platform 108 and the support feature 140 are arranged substantially parallel to the first side 116 of the cabinet 104 thereby positioning the medical simulation device 136 within the cabinet 104. When the simulation platform 108 is in the second platform position, the simulation platform 108 is arranged substantially perpendicular to the first side 116 of the cabinet 104 and protrudes from the door aperture 132 thereby positioning the medical simulation device 136 outside of the cabinet 104. The positioning slot 139 enables a user to slide a portion of the simulation platform 108 into and out of the cabinet 104, when the simulation platform 108 is in the second platform position,

In some non-limiting configurations, the positioning mechanism 138 can be a cross bar and one or more hinges, a mechanical linkage assembly, a rope and pulley system, one or more actuators, or any viable mechanism capable of moving the simulation platform 108 between the first platform position and the second platform position.

In the illustrated non-limiting example, the support feature 140 includes two support legs 148 each pivotally attached to the simulation platform 108. The support legs 148 are configured to be arranged substantially perpendicular to the simulation platform 108 when the simulation platform 108 is in the second platform position. The support legs 148 are dimensioned to engage the floor and support the simulation platform 108 when the simulation platform 108 is in the second platform position. Alternatively or additionally, the two support legs 148 can include one or more cross-members linking the two supports legs 148 together. In one non-limiting example, the support legs 148 can be self-leveling actuators configured to automatically arrange the simulation platform 108 parallel to the floor when the simulation platform 108 is in the second platform position. In other non-limiting examples, the support feature can include more or less support legs 148, as desired. In another non-limiting example, the support feature 140 can include a scissor support feature pivotally mounted to the simulation platform 108. The design of the platform support feature 140 and the simulation platform 108 can be such that the simulation platform 108 can support the static load of the medical simulation device 136 and a user, and any additional dynamic load applied to the simulation platform 108 without collapsing.

One non-limiting example of operations of the convertible simulation apparatus 100 will be described below with reference to FIGS. 9-11. When the door 112 is in the closed position, the simulation platform 108 is in the first platform position (shown using dashed lines in FIG. 9), and the convertible simulation apparatus 100 can be a storage cabinet, for example, in a conference room, break room, or office. When it is desired to use the medical simulation device 136, the door 112 can be moved from the closed position to the open position (FIG. 9). Once the door 112 is in the open position, the simulation platform 108 can then be moved from the first platform position to the second platform position by pivoting the simulation platform 108 via the positioning mechanism 138 and sliding the simulation platform 108 out of the cabinet 104 along the positioning slot 139. This positions the medical simulation device 136 outside of the cabinet 104 and provides a user of the convertible simulation apparatus 100 access to the medical simulation device 136. The user can then remove the straps 137 and perform the simulated medical procedure, therapy, operation or other training exercise on the medical simulation device 136 while the operator observes the user through the two-way mirror 120. Typically, the operator will be a trained medical professional.

For example, the user can perform chest compressions on the medical simulation device 136 to simulate CPR. In this non-limiting example, the user would be positioned on the simulation platform 108 and the user would apply an additional static load of between approximately 100 pounds and 250 pounds to the simulation platform 108. During the chest compressions, the user would also be applying a dynamic load of between approximately 100 pounds and 125 pounds to the simulation platform 108. The simulation platform 108 can be configured to support a peak dynamic load equal to the sum of the static loads from the medical simulation device 136 and the user, plus the additional force from the chest compressions. Thus, the peak dynamic load supported the simulation platform 22, in this non-limiting example, is approximately 525 pounds. In other non-limiting examples, the simulation platform 108 can be configured to support a peak dynamic load between approximately 400 pounds and 600 pounds.

As described above, one or more simulation control devices can be mounted on the operator mounting surface 128. This can enable the operator to control or monitor the medical simulation device 136. For example, the operator can monitor sensors and control actuators on the medical simulation device 138 while the user is performing the simulated medical procedure, therapy, or operation.

Once the user is finished with the medical simulation device 138, the simulation platform 108 can be moved from the second platform position to the first platform position, and the door 112 can be moved from the open position to the closed position. Upon moving the door 112 back into the closed position, the convertible simulation apparatus 100 can continue to be a storage cabinet until the medical simulation device 136 is needed.

Movement of the simulation platform 108 between the first platform position and the second platform position via the positioning mechanism 138 and the positioning slot 139 may be manually or electronically controlled by the user or the operator. For example, the convertible simulation apparatus 100 can include a control panel in electrical communication with the positioning mechanism 138. Alternatively, the convertible simulation apparatus 100 can include one or more manual movement devices, such as a pulley or a crank, mechanically coupled to the simulation platform 108.

Exemplary advantages of the above-described convertible simulation apparatus 10, 100 or other convertible simulation apparatuses designed or created using the above-identified techniques or properties, will be discussed below with references to FIGS. 1-11.

The convertible simulation apparatus 10 is configured to be used as a table when the cover 18 is in the first cover position and provide a user access to the medical simulation device 38 when needed. This allows the convertible simulation apparatus 10 to be used by medical facilities in conference rooms, break rooms, or offices without purchasing additional equipment for medical simulation training or dedicating a specific room to medical simulation training. Additionally, the simulation platform 22 and the platform support feature 42 can be designed such that the simulation platform 22 can support the weight of the medical simulation device 38, the user, and a dynamic load applied by the user. For example, the user may be simulating CPR and be positioned on the simulation platform 22 performing chest compressions. The simulation platform 22 can be prevented from collapsing under the force of the medical simulation device 38, the user, and the chest compressions performed by the user.

The convertible simulation apparatus 100 is configured to be used as a storage cabinet when the door 112 is in the closed position and provide a user access to the medical simulation device 136 when needed. This allows the convertible simulation apparatus 100 to be used by medical facilities in conference rooms, break rooms, or offices without dedicating a specific room to medical simulation training or purchasing expensive equipment such as hospital beds to hold the simulator. Additionally, the simulation platform 108 and the support feature 140 can be designed such that the simulation platform 108 can support the weight of the medical simulation device 136, the user, and a dynamic load applied by the user. For example, the user may be simulating CPR and be positioned on the simulation platform 108 performing chest compressions. The simulation platform 108 can be prevented from collapsing under the force of the medical simulation device 136, the user, and the chest compressions performed by the user.

Furthermore, the convertible simulation apparatus 100 allows an operator to monitor a user of the medical simulation device 136 without the user viewing the operator. The operator can control the medical simulation device 136 in real time while the user is performing the simulated medical procedure, therapy, operation, or other training exercise, heightening the clinical realism of the simulation. Increased accessibility to the medical simulation device via the convertible simulation apparatus can increase deliberate practice opportunities in performing the medical procedure, or other training exercise, resulting in better preparation to care for living patients.

It is to be understood that the invention is not limited in its application to the details of construction and the arrangement of components set forth in the preceding description or illustrated in the drawings. The invention is capable of other configurations and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The above discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The preceding detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Thus, while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

We claim:

1. A convertible simulation apparatus comprising:
an enclosure;
a simulation platform configured to receive a medical simulation device and moveable between a first position where the medical simulation device is positioned within the enclosure and a second position where the medical simulation device is positioned outside of the enclosure, wherein the simulation platform is configured to support a dynamic load in addition to a static load.

2. The convertible simulation apparatus of claim 1, wherein the static load is equal to the sum of a static load of the medical simulation device and a static load of a user.

3. The convertible simulation apparatus of claim 2, wherein the simulation platform is configured to support a peak dynamic load equal to a sum of the static load and the dynamic load.

4. The convertible simulation apparatus of claim 3, wherein the peak dynamic load is between approximately 400 pounds and 600 pounds.

5. The convertible simulation apparatus of claim 3, wherein the peak dynamic load is approximately 525 pounds.

6. A convertible simulation apparatus comprising:
a base defining a substantially open top side;
a cover attached to the base such that the cover is moveable between a first cover position where the cover covers the top side of the base and a second cover position where the cover does not cover the top side of the base; and
a simulation platform configured to receive a medical simulation device, the simulation platform being mounted within the base such that the simulation platform is moveable between a first platform position where the medical simulation device is positioned substantially below the top side of the base and a second platform position where the medical simulation device protrudes from the top side of the base, wherein the simulation platform is moveable between the first platform position and the second platform position when the cover is in the second cover position.

7. The convertible simulation apparatus of claim 6, wherein the base is mounted on a plurality of base mounting features.

8. The convertible simulation apparatus of claim 7, wherein the base mounting features are lockable casters.

9. The convertible simulation apparatus of claim 6, wherein the cover is attached to the base using a positioning mechanism.

10. The convertible simulation apparatus of claim 9, wherein the positioning mechanism includes one or more hinges each coupled to a slot configured to guide the hinges along the base and pivot the cover between the first cover position and the second cover position.

11. The convertible simulation apparatus of claim 6, wherein the simulation platform is mounted within the base using a platform support feature.

12. The convertible simulation apparatus of claim 11, wherein the platform support feature includes one or more hydraulic actuators.

13. The convertible simulation apparatus of claim 11, wherein the platform support feature is a scissor lift.

14. The convertible simulation apparatus of claim 11, wherein the platform support feature is a rotational mechanism configured to rotate the simulation platform between the first platform position and the second platform position.

15. The convertible simulation apparatus of claim 1, wherein the simulation platform includes at least one support handle each extending through a corresponding slot in the base.

16. A convertible simulation apparatus comprising:
a cabinet including a door pivotally mounted to a first side of the cabinet and defining a door aperture arranged on the first side of the cabinet and dimensioned to receive the door; and
a simulation platform configured to receive a medical simulation device and including a support feature pivotally attached to the simulation platform, the simulation platform being pivotally coupled to the cabinet such that the simulation platform is moveable between a first platform position where the simulation platform and the support feature are arranged substantially parallel to the first side of the cabinet thereby positioning the medical simulation device within the cabinet and a second platform position where the simulation platform is arranged substantially perpendicular to the first side of the cabinet and protrudes from the door aperture thereby positioning the medical simulation device outside of the cabinet, wherein the simulation platform is moveable between the first platform position and the second platform position when the door is in an open position.

17. The convertible simulation apparatus of claim 16, wherein the cabinet further includes a two-way mirror integrated into a second side of the cabinet.

18. The convertible simulation apparatus of claim 16, wherein the cabinet further includes an operator mounting surface pivotally mounted to a second side of the cabinet.

19. The convertible simulation apparatus of claim 16, wherein the cabinet is mounted on a plurality of cabinet mounting features.

20. The convertible simulation apparatus of claim 19, wherein the cabinet mounting features are lockable casters.

21. The convertible simulation apparatus of claim 16, wherein when the simulation platform is in the second platform position the support feature is configured to be arranged substantially perpendicular to the support platform.

22. The convertible simulation apparatus of claim 16, wherein the simulation platform is pivotally coupled to the cabinet using a positioning mechanism slidably received within a positioning slot.
